(19) United States
(12) Patent Application Publication
(10) Pub. No.: US 2004/0074320 A1
(43) Pub. Date: Apr. 22, 2004

(54) Specimen container chuck apparatus

(76) Inventor: Teruaki Itoh, Kumamoto-shi (JP)

Correspondence Address: NIXON & VANDERHYE, PC, 1100 N GLEBE ROAD, 8TH FLOOR, ARLINGTON, VA, 22201-4714, US

(21) Appl. No.: 10/651,047

(22) Filed: Aug. 29, 2003

(30) Foreign Application Priority Data
Aug. 30, 2002 (JP) 2002-253808

(51) Int. Cl. G01N 37/00

(52) U.S. Cl. 73/864.91

(57) ABSTRACT

A specimen container chuck apparatus includes an open/close driver and a pair of holding members which are provided to hold a specimen container from an outer surface thereof. Each of the holding members is formed by bending a linear member having elasticity and includes a pair of support sections which extend in parallel along the outer surface of the specimen container, one end of each of the support sections being coupled to the open/close driver, a pair of container contact sections which are connected at one end to the support sections, respectively and bent and biased toward the outer surface of the specimen container, and a coupling section which couples the other ends of the container contact sections and are curved so as to surround the outer surface of the specimen container with a given gap therebetween.

### CROSS-REFERENCE TO RELATED APPLICATIONS

This application is based upon and claims the benefit of priority from the prior Japanese Patent Application No. 2002-253808, filed Aug. 30, 2002, the entire contents of which are incorporated herein by reference.

### BACKGROUND OF THE INVENTION

1. Field of the Invention

The present invention relates to a specimen container chuck apparatus favorable for a specimen preprocessing apparatus and the like used for, e.g., a blood test.

2. Description of the Related Art

A specimen container chuck apparatus generally comprises an open/close driver including an electric motor and an actuator and a holding member that is opened and closed by the open/close driver and commonly known as a finger. The holding member is used to hold a specimen container such as a test tube from both sides. Most of holding members of prior art specimen container chuck apparatuses are each made up of a pair of plate members, and the plate members are arranged such that their inner surfaces are opposed to each other.

The inner surfaces of the paired plate members are each shaped like an arc having a specific degree of bend. Thus, a specimen container can stably be held when its outer surface conforms to the arc of each of the plate members. However, the specimen container becomes difficult to hold stably when the outer surface does not conform thereto.

Specimen containers such as test tubes are not necessarily standardized in terms of width, length, angle of inclination of tapered observation surface, and the like. In order to obtain a holding member common to different specimen containers, a cushion material such as felt is stuck on the arc surface of the holding member and the holding member itself is formed of a relatively soft material. These methods however complicate the configuration of the holding member itself. Furthermore, the force by which the specimen containers are held is likely to be unstable.

The above-described holding member is generally manufactured by cutting block-shaped steel materials or the like. The manufacturing costs are therefore difficult to lower.

### BRIEF SUMMARY OF THE INVENTION

An object of the present invention is to provide a specimen container chuck apparatus including a holding member that is common to different specimen containers and can be manufactured inexpensively.

In order to attain the above object, the specimen container chuck apparatus according to the present invention has the following characteristic configuration. The other characteristic configurations will be clarified in the detailed description of the invention.

A specimen container chuck apparatus according to the present invention comprises an open/close driver and a pair of holding members which are opened and closed by the open/close driver and provided to hold a specimen container from an outer surface thereof, wherein each of the holding members is formed by bending a linear member having elasticity and includes a pair of support sections which extend in parallel along the outer surface of the specimen container, one end of each of the support sections being coupled to a drive end of the open/close driver, a pair of container contact sections which are connected at one end to the support sections, respectively and bent and biased toward the outer surface of the specimen container, and a coupling section which couples other ends of the container contact sections and are curved so as to surround the outer surface of the specimen container with a given gap therebetween.

### BRIEF DESCRIPTION OF THE SEVERAL VIEWS OF THE DRAWING

FIG. 1A is a schematic front view of a specimen container chuck apparatus according to an embodiment of the present invention.

FIG. 1B is a schematic side view of the specimen container chuck apparatus according to an embodiment of the present invention.

FIG. 2 is a sectional view taken along line 2-2 of FIG. 1A.

FIG. 3 is a perspective view of the principal part of a holding member in the specimen container chuck apparatus according to the embodiment of the present invention.

### DETAILED DESCRIPTION OF THE INVENTION

(Embodiment)

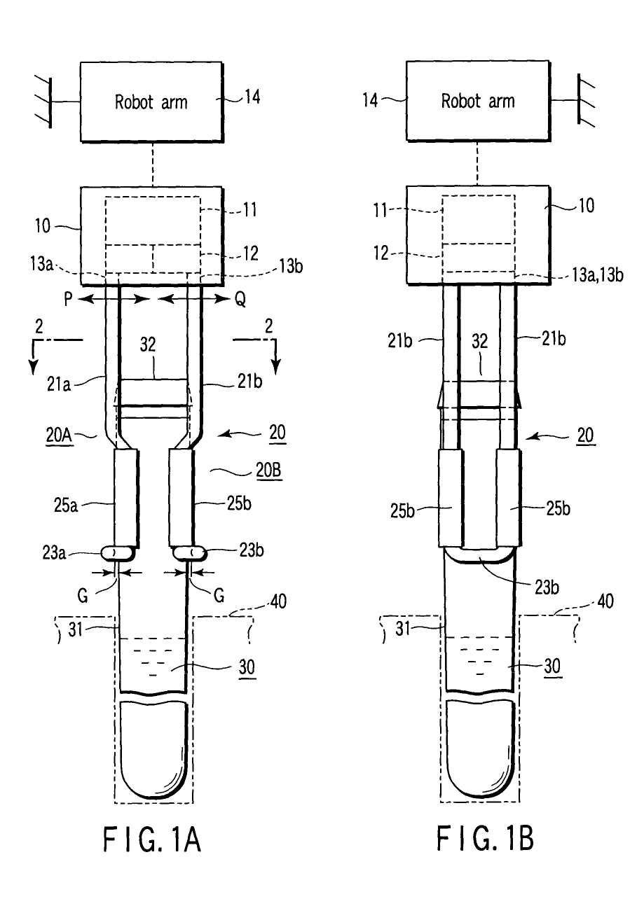

In FIGS. 1A and 1B, reference numeral 10 denotes an open/close driver, 20 indicates a holding member and 30 shows a specimen container. The open/close driver 10 is a combination of an electric motor 11 such as a rotary solenoid and an actuator 12. The driver 10 includes drive ends 13a and 13b that perform an open/close operation. The driver 10 is attached to, for example, a robot arm 14 by which the driver 10 can be moved three-dimensionally.

The holding member 20 has a pair of holding members 20A and 20B opposed to each other. One end of the holding member 20A is connected to the drive end 13a of the open/close driver 10 and one end of the holding member 20B is connected to the drive end 13b thereof. The holding members 20A and 20B are made closer to and separated from each other by the open/close driver 10, as indicated by arrows P and Q in FIG. 1A, with the result that they can hold the specimen container 30 from the outer surface.

The specimen container 30 is, for example, a test tube containing a specimen such as blood. The specimen container 30 includes a container main body 31 and a stopper 32 with which the opening of the specimen main body 31 is sealed. The specimen container 30 of the present embodiment is a so-called tapered specimen container whose observation surface is tapered. In other words, the specimen container 30 is gradually thinned toward the bottom from the opening. The specimen container 30 can be stocked and held in a specimen container rack 40 indicated by the two-dot-one-dash line.

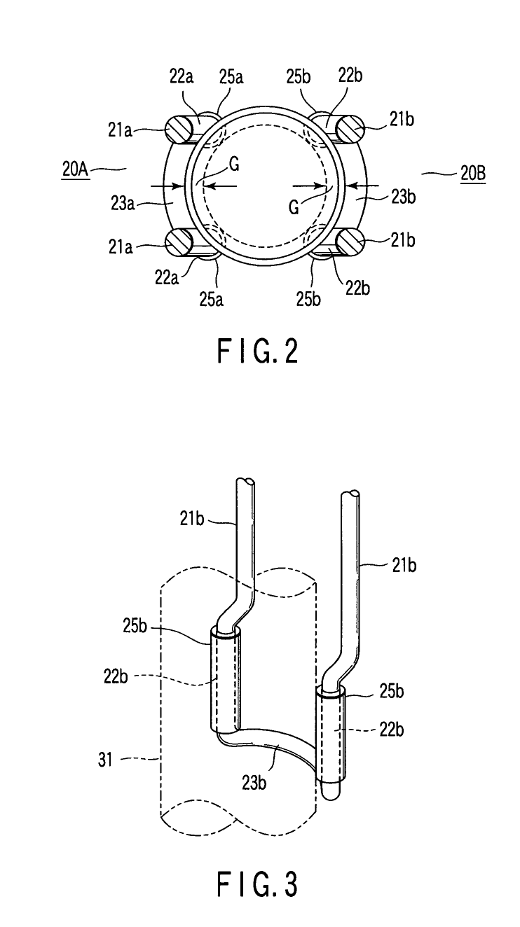

As illustrated in FIGS. 1A, 1B, 2 and 3, each of the holding members 20A and 20B is a base member formed by bending a linear member of elastic metal wire that is made of, e.g., phosphor bronze.

Paying attention to one of the holding members, i.e., the holding member 20A, it is made up of three parts of a pair of support sections 21a and 21a, a pair of container contact sections 22a and 22a, and a coupling section 23a.

One end of each of the support sections 21a and 21a is coupled to the drive end 13a of the open/close driver 10, and the support sections 21a and 21a extend in parallel along the outer surface of the specimen container 30. The container contact sections 22a and 22a are connected at one end to the support sections 21a and 21a, respectively and bent and biased toward the outer surface of the specimen container 30 such that they can contact the outer surface. The coupling section 23a couples the other ends of the container contact sections 22a and 22a and are curved so as to surround the outer surface of the specimen container 30 with a given gap G therebetween. Tubes 25a and 25a, which are made up of soft members such as rubber and flexible resin, are fitted on the container contact sections 22a and 22a, respectively.

Paying attention to the other holding member 20B, it is made up of three parts of a pair of support sections 21b and 21b, a pair of container contact sections 22b and 22b, and a coupling section 23b.

One end of each of the support sections 21b and 21b is coupled to the drive end 13b of the open/close driver 10, and the support sections 21b and 21b extend in parallel along the outer surface of the specimen container 30. The container contact sections 22b and 22b are connected at one end to the support sections 21b and 21b, respectively and bent and biased toward the outer surface of the specimen container 30 such that they can contact the outer surface. The coupling section 23b couples the other ends of the container contact sections 22b and 22b and are curved so as to surround the outer surface of the specimen container 30 with a given gap G therebetween. Tubes 25b and 25b, which are made up of soft members such as rubber and flexible resin, are fitted on the container contact sections 22b and 22b, respectively.

An operation of the specimen container chuck apparatus configured as described above will now be described. The robot arm 14 moves the specimen container chuck apparatus moves to a position where the specimen container 30 is located. In this position, the holding members 20A and 20B open and lower. The holding members 20A and 20B stops lowering when the container contact sections 22a and 22a and 22b and 22b move down to the holding position while straddling the specimen container 30. Then, the holding members 20A and 20B are closed, with the result that the tubes 25a and 25a fitted on the container contact sections 22a and 22a and the tubes 25b and 25b fitted on the container contact sections 22b and 22b contact the outer surface of the specimen container 30 and hold the container 30. When the specimen container 30 is caught, the specimen container chuck apparatus is moved up by the robot arm 14 and then moved horizontally to a given position. In the given position, the specimen container chuck apparatus lowers, and the holding members 20A and 20B open. Thus, the specimen container 30 is stocked and held in the specimen container 40 located in the given position.

(Features of the Embodiment)

[1] A specimen container chuck apparatus according to an embodiment of the present invention, comprises an open/close driver 10 and a pair of holding members 20A and 20B which are opened and closed by the open/close driver 10 and provided to hold a specimen container 30 from an outer surface thereof,

wherein each of the holding members 20A and 20B is formed by bending a linear member having elasticity and, for example, the holding member 20B includes a pair of support sections 21b and 21b which extend in parallel along the outer surface of the specimen container 30, one end of each of the support sections 21b and 21b being coupled to a drive end 13b of the open/close driver 10, a pair of container contact sections 22b and 22b which are connected at one end to the support sections 21b and 21b, respectively and bent and biased toward the outer surface of the specimen container 30, and a coupling section 23b which couples the other ends of the container contact sections 22b and 22b and are curved so as to surround the outer surface of the specimen container 30 with a given gap G therebetween.

In the specimen container chuck apparatus described above, the holding members 20A and 20B are not bulky because they are formed by bending a linear member having elasticity as a base member. Chucking can thus be performed in a narrow place. Each of the holding members 20A and 20B is curved with its corresponding support sections, container contact sections and coupling section connected integrally as one component. Necessary rigidity can be obtained though a linear member is used as the base member. Consequently, the specimen container 30 can be held by adequate force. Since, furthermore, the base members of the holding members 20A and 20B can be formed by bending linear members, block-shaped steel materials need not be cut. The apparatus can thus be manufactured inexpensively.

[2] The specimen container chuck apparatus according to the above item [1], further comprises tubes 25a and 25a and 25b and 25b which are made up of soft members and fitted on the container contact sections 22a and 22a and 22b and 22b, respectively.

In the above specimen container chuck apparatus, the tubes 25a and 25a and 25b and 25b that are made up of soft members are fitted on the container contact sections 22a and 22a and 22b and 22b, so that the apparatus can be applied to various specimen containers of different sizes and tapered specimen containers. Since friction increases, there is no fear of a drop of the specimen container 30 due to a slip when the specimen container 30 is conveyed.

[3] In the specimen container chuck apparatus according to the above item [1], the holding members 20A and 20B are formed of metal wire having elasticity.

[4] In the specimen container chuck apparatus according to the above item [1], the tubes 25a and 25b are formed of soft members such as rubber and soft resin.

(Modification)

The specimen container chuck apparatus according to the embodiment can be modified as follows:

The base member of the holding member can be made of, e.g., synthetic resin wire other than the metal wire. In this case, the tubes 25b and 25b can be removed.

What is claimed is:

1. A specimen container chuck apparatus comprising an open/close driver and a pair of holding members which are opened and closed by the open/close driver and provided to hold a specimen container from an outer surface thereof,
wherein each of the holding members is formed by bending a linear member having elasticity and includes a pair of support sections which extend in parallel along the outer surface of the specimen container, one end of each of the support sections being coupled to a drive end of the open/close driver, a pair of container contact sections which are connected at one end to the support sections, respectively and bent and biased toward the outer surface of the specimen container, and a coupling section which couples other ends of the container contact sections and are curved so as to surround the outer surface of the specimen container with a given gap therebetween.

2. The specimen container chuck apparatus according to claim 1, further comprising tubes which are made up of soft members and fitted on the container contact sections, respectively.

3. The specimen container chuck apparatus according to claim 1, wherein the holding members are formed of metal wire having elasticity.

4. The specimen container chuck apparatus according to claim 1, wherein the tubes are formed of soft members such as rubber and soft resin.
